(19) United States
(12) Patent Application Publication
(10) Pub. No.: US 2006/0070296 A1
(43) Pub. Date: Apr. 6, 2006

(54) Planting device for a stairway

(76) Inventor: Gregg G. Bergstrom, Leyden, MA (US)

Correspondence Address: STEVEN N. FOX, ESQ., P.O. BOX 251, CANTON, MA, 02021, US

(21) Appl. No.: 10/957,210

(22) Filed: Oct. 1, 2004

(51) Int. Cl. A01G 9/02

(52) U.S. Cl. 47/65.5

(57) ABSTRACT

The present invention a device for planting flowers that can be mounted on the two consecutive steps of a stairway. In one embodiment, the device comprising a receptacle body having first and second floor portions, a sidewall portion, and an open top portion. The first and second floor portions having a depth d1 and d2 from the open top portion. The distance d1 is greater than the distance d2 for engagement with the consecutive steps of the stairway. The first floor portion has first and second drain openings. The device further comprises a catch basin removably engaged with said first bottom portion of said main body and adapted to receive water from the first and second drain openings of the first floor portion. In operation, the catch basin and the second floor portion may be engaged with the consecutive steps of the stairway and soil may be placed within the receptacle body. Any water not absorbed by the soil passes thru the first and second drain openings into the catch basin. The catch basin may be removed periodically to empty any collected water.

### BACKGROUND OF THE INVENTION

Planters are well known in the gardening industry as container for holding soil and for growing flowers therein. Such conventional planters are circular or rectangular shaped low and high profile containers having an open top portion, and are made from wooden and metal parts.

### SUMMARY OF THE INVENTION

The present invention a device for planting flowers or the like that can be mounted on the two consecutive steps of a stairway. In one embodiment, the device comprising a receptacle body having first and second floor portions, a sidewall portion, and an open top portion. The first and second floor portions having a depth d1 and d2 from the open top portion. The distance d1 is greater than the distance d2 for engagement with the consecutive steps of the stairway. The first floor portion has first and second drain openings. The device further comprises a catch basin removably engaged with said first bottom portion of said main body and adapted to receive water from the first and second drain openings of the first floor portion. In operation, the catch basin and the second floor portion may be engaged with the consecutive steps of the stairway and soil may be placed within the receptacle body. Any water not absorbed by the soil passes thru the first and second drain openings into the catch basin. The catch basin may be removed periodically to empty any collected water.

### BRIEF DESCRIPTION OF DRAWINGS

The following detailed description of the invention will be more easily understood with reference to the accompanying drawings, in which;

FIG. 1 is a perspective view of the present invention engaged with a stair;

FIG. 2 is an exploded perspective view of the present invention showing the main body and the catch basin;

FIG. 3 is a cross section view of the main body taken along line 3-3 of FIG. 3;

FIG. 4 is a cross section view of the catch basin taken along line 4-4 of FIG. 3;

FIG. 5 is front view of the present invention;

FIG. 6 is a side view of the present invention (the opposite side being identical);

FIG. 7 is a rear view of the present invention;

FIG. 8 is a bottom view of the present invention; and

FIG. 9 is a top view of the present invention.

### DESCRIPTION OF THE INVENTION

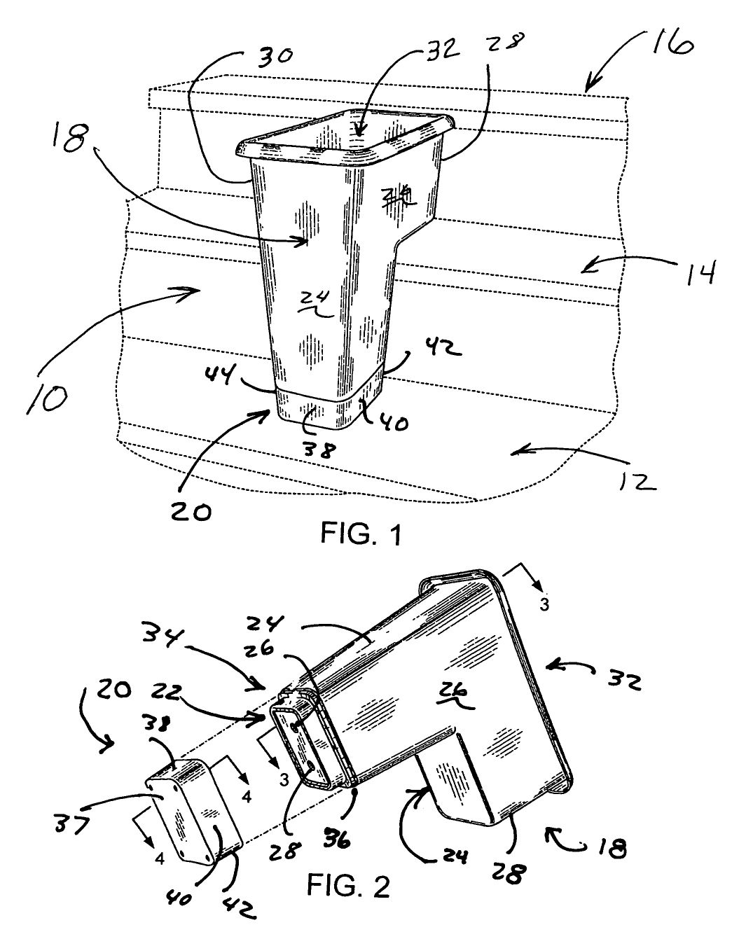

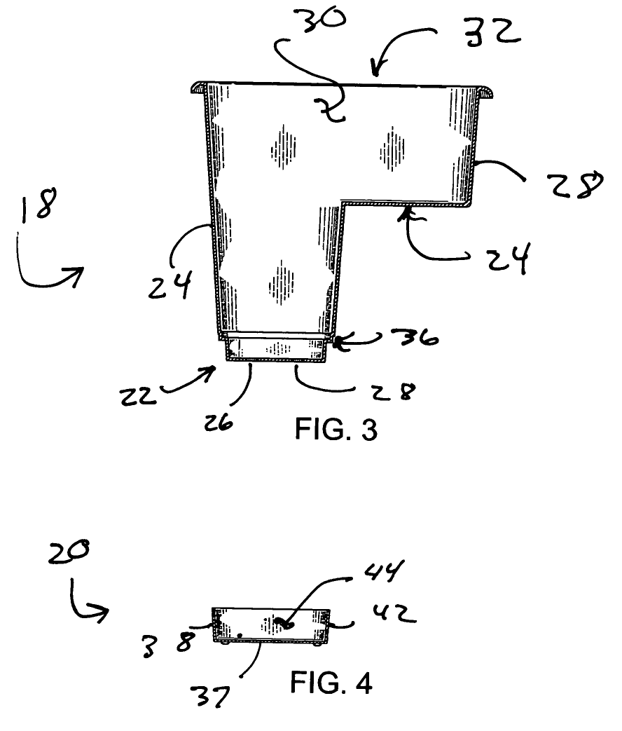

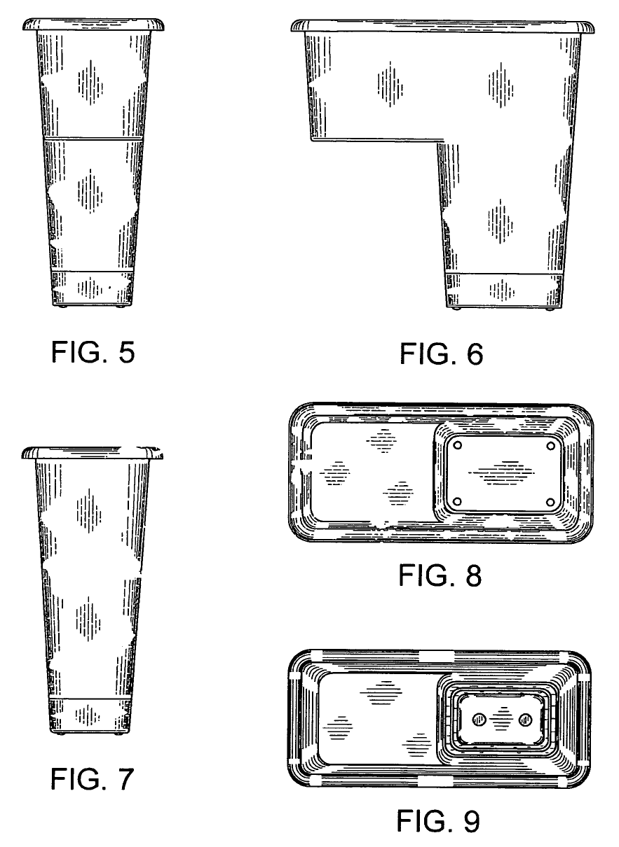

Referring to FIGS. 1-5, the present invention a device 10 for planting flowers (not shown) that can be mounted on the two consecutive steps 12 and 14 of a stairway 16. The device 10 generally comprises a receptacle body 18 and a catch basin 20 removably engaged with the receptacle body 18. The receptacle body 18 generally comprises first and second floor portions 22 ad 24, sidewall portions 26, 28, 30, and 32 forming an open top portion 34. The first and second floor portions 22 and 24 having a depth d1 and d2, respectively, from the open top portion. Distance d1 is greater than the distance d2 for engagement of the second floor portion 24 with the step 14 of the stairway 16. The first floor portion 22 has first and second drain openings 26 and 28. The catch basin 20 is removably engaged with first floor portion of the receptacle body 18. The catch basin 20 is in communication with the first and second drain openings 26 ad 28 to collect any water draining from the first and second drain openings 26 and 28 of the first floor portion 22. Each of the first and second floor portions 22 and 24 are substantially planar. The first floor portion 22 comprises a recessed end portion 34 disposed inward from the sidewalls 24, 26, 28, and 30 of the receptacle body 18. The recessed end portion 34 comprises a shoulder portion 36 disposed about the recessed portion 34 and adapted to engage with the catch basin 18. The catch basin 20 comprises a floor 37, sidewalls 38, 40, 42, and 44, each having an upper end portion 46 adapted to removably engage with the shoulder portion 36. Upon engagement of the catch basin 20 with the receptacle 18, the distance (or collection depth) from the floor of the catch basin 20 to the first and second drain openings 24 and 26 is about 0.250 inches. The first and second drain openings 24 and 26 may circular shaped and formed as part of the first floor portion 22 or may be of a variety of other shapes such as square or rectangular or any channel or passage way, integrally formed or not, which is capable of allowing water to drain into the catch basin 20. The receptacle body 18 and the catch basin 20 are made from rigid plastic and may be formed by conventional fabrication processes such as injection or blow molding.

In operation, the catch basin 20 and the second floor portion 24 may be engaged with the consecutive steps 12 and 14, respectively, of the stairway 1 and soil may be placed within the receptacle body 18. Any water not absorbed by the soil passes thru the first and second drain openings 26 and 28 into the catch basin 20. The catch basin 20 may be removed periodically to empty any collected water.

The foregoing description is intended primarily for purposes of illustration. This invention may be embodied in other forms or carried out in other ways without departing from the spirit or scope of the invention. Modifications and variations still falling within the spirit or the scope of the invention will be readily apparent to those of skill in the art.

What is claimed:

1. A device for planting flowers on first and second consecutive steps of a stairway, the device comprising:
a receptacle body comprising first and second floor portions, a sidewall portion, and an open top portion; said first and second floor portions having a depth d1 and d2 from said open top portion said distance d1 being greater than said distance d2; said first floor portion having a first drain opening; and
a catch basin removably engaged with said receptacle body and adapted to receive water from said first drain opening of said first floor portion,
whereby said catch basin and said second floor portion may be engaged with the first and second steps of the stairway and soil may be placed within said receptacle body and any water not absorbed by the soil will drain thru said first drain opening into said catch basin.

2. The device of claim 1, wherein second floor portion is substantially planar.

3. The device of claim 2, wherein said first floor portion comprises a recessed end portion disposed inward from said sidewall of said receptacle.

4. The device of claim 3, recessed end portion comprise a shoulder portion disposed about said recessed portion and adapted to engage with said catch basin.

5. The device of claim 4, wherein said first floor portion comprises a second drain opening to allow water to drain to said catch basin.

6. The device of claim 5, wherein said catch basin comprises a floor, a sidewall having an upper end portion adapted to removably engage with said shoulder portion.

7. The device of claim 6, wherein upon engagement of said catch basis with said receptacle, said distance from said floor of said catch basin to said first and second drain openings is about 0.250 inches.

8. The device of claim 7, wherein said first and second drain opening are circular shaped.

9. The device of claim 8, wherein said receptacle body is made from rigid plastic.

10. The device of claim 9, wherein said catch basin is made from rigid plastic.
